(19) United States
(12) Patent Application Publication
(10) Pub. No.: US 2026/0162051 A1
(43) Pub. Date: Jun. 11, 2026

(54) AI-INTEGRATED ORDER-SPECIFIC INTERFACE

(71) Applicant: RunBuggy OMI, Inc., Ontario, CA (US)

(72) Inventor: Sasha Jovicic, Parkland, FL (US)

(21) Appl. No.: 19/409,327

(22) Filed: Dec. 4, 2025

Related U.S. Application Data
(60) Provisional application No. 63/730,790, filed on Dec. 11, 2024.

(51) Int. Cl. G06Q 10/0835; G06Q 10/0833

(52) U.S. Cl. CPC G06Q 10/0835; G06Q 10/0833

(57) ABSTRACT

Systems and methods for a transportation management system provide for: generating an order-specific user interface that is specific to a vehicle transportation order for a vehicle to be transported, the first user interface to include: an order information portion to indicate information related to the vehicle transportation order; and an order communication portion to receive input related to vehicle transportation; receiving, via the first user interface, an input related to the vehicle transportation order; and, responsive to receipt of the input, update the order-specific user interface based on the input related to the vehicle transportation order.

### CROSS-REFERENCE TO RELATED APPLICATIONS

This application claims priority to U.S. patent application Ser. No. 63/730,790 filed Dec. 11, 2024, and entitled, “AI-Integrated Order-Specific Interface,” which is hereby incorporated by reference in its entirety.

### SUMMARY

Various aspects of the present disclosure relate to artificial intelligence (AI) integrated logistics systems and methods for implementation within an electronic transportation management system (TMS), and, in particular, to an AI-integrated order-specific interface that advantageously improves electronic communication and automated operational task management within the TMS.

The disclosed technology relates to systems and methods for an electronic transportation management system (TMS). Some embodiments of the disclosure provide an electronic transportation management system. The system may include a processing system comprising one or more electronic processors. The processing system may be configured to generate a first user interface that is specific to a first vehicle transportation order for a vehicle to be transported, the first user interface to include: an order information portion to indicate information related to the first vehicle transportation order; and an order communication portion to receive input related to vehicle transportation. The processing system may be configured to receive, via the first user interface, an input related to the first vehicle transportation order. The processing system may be configured to, responsive to receipt of the input, update the first user interface based on the input related to the first vehicle transportation order.

Other embodiments of the disclosure provide a method. The method may include generating, with a processing system including one or more electronic processors, a first user interface that is specific to a first vehicle transportation order for a vehicle to be transported, the first user interface to include: an order information portion to indicate information related to the first vehicle transportation order; and an order communication portion to receive input related to vehicle transportation. The method may include receiving, with the processing system, via the first user interface, an input related to the first vehicle transportation order. The method may include, responsive to receipt of the input, updating, with the processing system, the first user interface based on the input related to the first vehicle transportation order.

Other embodiments of the disclosure provide a non-transitory computer-readable medium storing instructions that, when executed by one or more electronic processors of a processing system, cause the processing system to perform operations comprising: generating a first user interface that is specific to a first vehicle transportation order for a vehicle to be transported, the first user interface to include: an order information portion to indicate information related to the first vehicle transportation order; and an order communication portion to receive input related to vehicle transportation; receiving, via the first user interface, an input related to the first vehicle transportation order; and, responsive to receipt of the input, updating the first user interface based on the input related to the first vehicle transportation order.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates a system level block diagram for providing a transportation management system (TMS) in accordance with some configurations.

FIG. 2 illustrates a server included in the system of FIG. 1 in accordance with some configurations.

FIG. 3 is a screenshot of an example TMS user interface in accordance with some configurations herein.

FIG. 4 is another screenshot of an example TMS user interface in accordance with some configurations herein.

FIG. 5 is another screenshot of an example TMS user interface in accordance with some configurations herein.

FIG. 6 is another screenshot of an example TMS user interface in accordance with some configurations herein.

FIG. 7 is a screenshot of an example messaging portion of an example TMS user interface in accordance with some configurations herein.

FIG. 8 illustrates an example order-specific user interface in accordance with some configurations.

FIG. 9 is a flowchart illustrating an example method to control communications within the TMS platform using an AI-integrated order-specific interface in accordance with some configurations.

FIG. 10 is a screenshot of an example order-specific user interface in accordance with some configurations.

FIG. 11 is another screenshot of an example order-specific user interface in accordance with some configurations.

FIG. 12 is another screenshot of an example order-specific user interface in accordance with some configurations.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

Purchasing, selling, and ultimately shipping bulk products involves many moving pieces. Typically, purchasing managers (and correspondingly sales managers) correspond with shippers (or transporters) to schedule logistics. However, once scheduled, a purchase or sales manager may not, or may not even be able to (e.g., do not have the contact information of the truck driver, transportation company, etc.) receive updates from a transport company (or truck driver specifically). Although this may be manageable in small-scale situations, where such a manager can contact the company for updates, this becomes extremely difficult, if not impossible, at larger scales. In fact, as logistical networks become more complex and numerous (e.g., number of products, types of products, number of trucks, etc.) keeping track of products including deliveries (e.g., outgoing and incoming) in a timely manner is not realistic. As timing of deliveries becomes ever more demanding from the business or consumer side, better systems and methods are needed to facilitate communication between transporters and shippers.

Some embodiments of the disclosure address these problems (and others) by providing an order-specific user interface. This order-specific user interface can provide a single location for multiple streams of information pertaining to orders. More specifically, the order-specific user interface can include both a messaging interface and an order interface all within the same window of an application (e.g., of a display device). The order interface can display different orders, while the messaging interface can facilitate communication pertaining to that specific order (e.g., when selected). In this way, a user does not have to leave an order-specific interface to, e.g., interact with another user about that specific order, but rather multiple types of functionality or all functionality available for an order may be performed within the order-specific interface (as opposed to discrete interfaces). For instance, a shipper is able to interact with an order using a single conversational interface that is order specific such that the shipper may see, e.g., order history, order status, order conversation(s), etc. within a single interface.

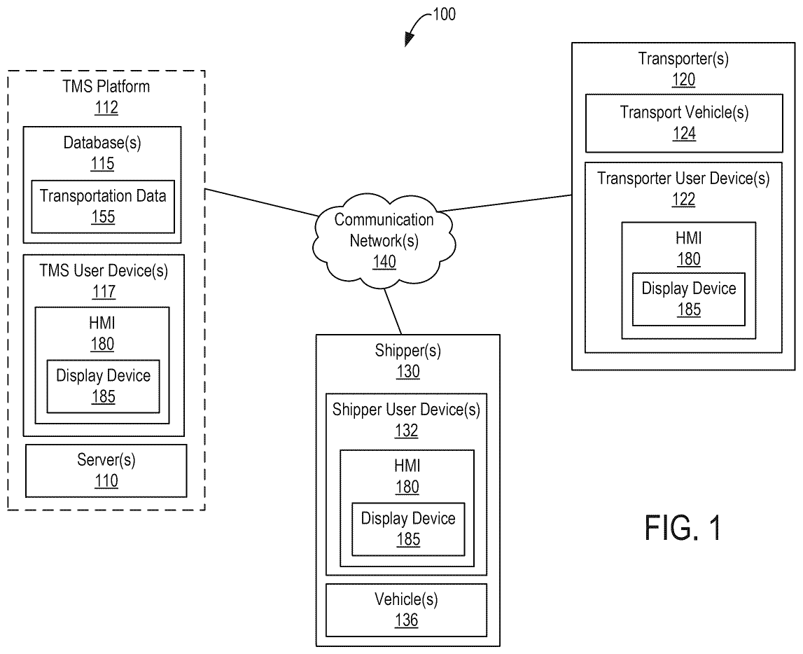

FIG. 1 schematically illustrates a system 100 to provide a TMS having artificial intelligence (AI) integrated logistics and functionality in a distributed computing environment in accordance with some configurations. The system 100 includes a TMS platform 112. As illustrated in FIG. 1, the TMS platform 112 may include a server 110 implementing (or otherwise hosting) a TMS, one or more databases 115, and one or more TMS user devices 117, as described in greater detail herein. The system 100 may also include one or more transporters 120 and one or more shippers 130. As illustrated in FIG. 1, the transporter(s) 120 may be associated with one or more transporter user devices 122, one or more transport vehicles 124, or a combination thereof, as described in greater detail herein. The system 100 may also include one or more shippers 130. The shipper(s) 130 may be associated with one or more shipper user devices 132, one or more vehicles 136 (e.g., vehicles to be transported), or a combination thereof, as described in greater detail herein.

In some configurations, the system 100 includes fewer, additional, or different components than illustrated in FIG. 1. Also, in some configurations, the database(s) 115 may be included in the server 110, the TMS user device(s) 117, or a combination thereof, and one or both of the database(s) 115 and the server 110 may be distributed among multiple databases or servers. Alternatively, or in addition, in some configurations, components of the system 100 may be combined into a single device (e.g., the database 115, the TMS user device(s) 117, and the server 110).

The TMS platform 112 (e.g., the server 110, the database(s) 115, and the TMS user device(s) 117), the transporter(s) 120 (e.g., the transporter user device(s) 122), and the shipper(s) 130 (e.g., the shipper user device(s) 132) communicate over one or more wired or wireless communication networks 140. Portions of the communication networks 140 may be implemented using a wide area network, such as the Internet, a local area network, such as Bluetooth™ network or Wi-Fi, and combinations or derivatives thereof. In some configurations, additional communication networks may be used to allow one or more components of the system 100 to communicate. Also, in some embodiments, components of the system 100 may communicate directly as compared to through a communication network 140 and, in some configurations, the components of the system 100 may communicate through one or more intermediary devices not illustrated in FIG. 1.

The shipper(s) 130 may be associated with one or more vehicle(s) 136 to be transported (e.g., from a pick-up location (or starting location) to a drop-off location (or destination)). Accordingly, the shipper(s) 130 may be a user or entity that seeks transportation of one or more vehicle(s) 136. A vehicle 136 may include, e.g., an automobile (e.g., a car, a truck, a van, etc.), a motorcycle, a scooter, a moped, a utility vehicle (e.g., a utility task vehicle (UTV), an all-terrain vehicle (ATV), etc.), a golf cart, equipment or machinery (e.g., a compact loader, a tractor, a forklift, a trencher, a brush cutter, a ride-on lawnmower, etc.), etc. While the technology disclosed herein is described with reference to an automobile, it should be understood that, in some configurations, the technology disclosed herein may be implemented with respect to various types of vehicles and should not be limited to automobiles.

The transporter(s) 120 may be a user or entity that performs vehicle transportation operations, such as, e.g., transporting the vehicle(s) 136 from a pick-up location to a drop-off location. In some instances, the transporter(s) 120 may include, e.g., a driver, a transport company, a transport company user, or another suitable person or entity to perform vehicle transportation operations. The transporter(s) 120 may perform the vehicle transportation operations using one or more of the transport vehicle(s) 124. The transport vehicle(s) 124 may include, e.g., a single-level trailer, a multi-level trailer, a single-car trailer, a multi-car trailer, an enclosed trailer, an open car trailer, a semi-trailer, a flatbed trailer, a freight truck, an auto carrier, an enclosed multi-level car carrier, etc. In some instances, the transport vehicle(s) 124 may be implemented using an additional tow-vehicle. As one example, the transport vehicle 124 may be a semi-trailer truck that includes a tractor unit and a semi-trailer. As another example, the transport vehicle 124 may include a truck or tractor and a flatbed trailer.

A TMS user may be a user or entity that manages or maintains the TMS (e.g., the TMS platform 112). For instance, the TMS user may be an internal user of the TMS platform 112. The TMS user may be associated with the TMS user device(s) 117. For example, the TMS user may be an administrative user, an operations user, an information technology user, a customer service representative user, etc. for the TMS (e.g., the TMS platform 112).

The server 110 can include one or more server(s) (e.g., one or more cloud servers, data servers, computing devices, computers, etc. and collectively referred to herein as “the server 110”) and other components that may implement certain embodiments and features (e.g., the TMS or platform thereof) described herein. Other devices, such as specialized sensor devices, etc., may interact with the server 110.

As noted herein, the server 110 may implement a TMS via, e.g., the TMS platform 112. The TMS platform 112 may be a computing platform (such as, e.g., a hardware and software architecture) that enables TMS related functionality. A “platform” is generally understood to refer to hardware or software used to host an application or service, such as, e.g., the TMS or the TMS platform 112 described herein. In the context of the technology disclosed herein, a “TMS platform” may refer to hardware or software used to host a TMS application or TMS service (e.g., a hardware and software architecture that functions as a foundation upon which TMS applications, services, processes, or the like are implemented). For instance, as noted herein, the technology disclosed herein may provide artificial intelligence (AI) integrated logistics systems and methods for implementation within an electronic transportation management system (e.g., the TMS), and, in particular, to an AI-integrated order-specific user interface that advantageously improves electronic communication and automated operational task management within the TMS. Accordingly, in some instances, the server 110 may implement (or host) a TMS via the TMS platform 112 to provide improved AI-integrated logistics solutions and services, including, e.g., an AI-integrated order-specific user interface that advantageously improves electronic communication and automated operational task management.

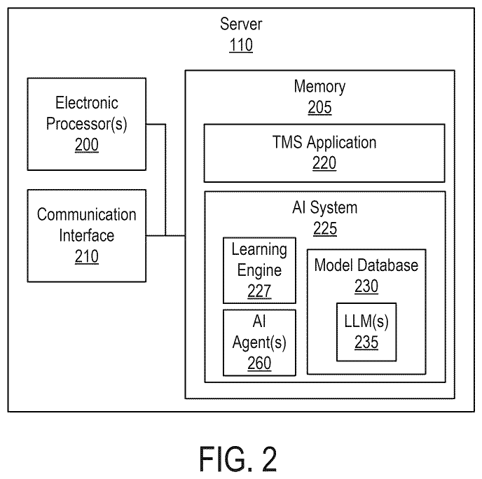

As illustrated in FIG. 2, the server 110 includes one or more electronic processors 200 (collectively referred to herein as “the electronic processor 200”), a memory 205, and a communication interface 210. The electronic processor 200, the memory 205, and the communication interface 210 communicate through wired connections or wirelessly, over one or more communication lines or buses, or a combination thereof. The server 110 may include additional, different, or fewer components than those illustrated in FIG. 2 in various configurations. For example, the server 110 may also include one or more human machine interfaces, such as a keyboard, keypad, mouse, joystick, touchscreen, display device, printer, microphone, neural link device (e.g., a neural implant device or integrated circuit (IC) configured to provide, e.g., a brain-computer interface), speaker, and the like, that receive input from a user, provide output to a user, or a combination thereof. The server 110 may also perform additional functionality other than the functionality described herein. Also, the functionality (or a portion thereof) described herein as being performed by the server 110 may be distributed among multiple servers or devices (for example, as part of a cloud service or cloud-computing environment), may be performed by one or more user devices (e.g., the TMS user device(s) 117, the transporter user device(s) 122, the shipper user device(s) 132, etc.), or a combination thereof.

The communication interface 210 allows the server 110 to communicate with devices external to the server 110. For example, as illustrated in FIG. 1, the server 110 may communicate with the database(s) 115, the TMS user device(s) 117, the transporter user device(s) 122, the shipper user device(s) 132, or a combination thereof through the communication interface 210. The communication interface 210 may include a port for receiving a wired connection to an external device (for example, a universal serial bus (“USB”) cable and the like), a transceiver for establishing a wireless connection to an external device (for example, over one or more communication networks 140, such as the Internet, local area network (“LAN”), a wide area network (“WAN”), and the like), or a combination thereof.

The electronic processor 200 is configured to access and execute computer-readable instructions (“software”) stored in the memory 205. The software may include firmware, one or more applications, program data, filters, rules, one or more program modules, and other executable instructions. For example, the software may include instructions and associated data for performing a set of functions, including the methods described herein.

As illustrated in FIG. 2, the memory 205 may include a TMS application 220 (referred to herein as “the application 220”). The application 220 is a software application executable by the electronic processor 200. As described in more detail herein, the electronic processor 200 executes the application 220 to perform one or more TMS processes or functionality. In some configurations, the application 220 (when executed by the electronic processor 200) may perform the TMS processes or functionality described in greater detail herein by interacting with (or otherwise implementing) functionality of an artificial intelligence (AI) system 225. As illustrated in FIG. 2, the AI system 225 may include a learning engine 227 and a model database 230.

In some configurations, the learning engine 227 develops one or more models using one or more machine learning functions. Machine learning functions are generally functions that allow a computer application to learn without being explicitly programmed. In particular, the learning engine 227 is configured to develop an algorithm or model based on training data. As one example, to perform supervised learning, the training data includes example inputs and corresponding desired (for example, actual) outputs, and the learning engine 227 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 227 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 227 to ingest, parse, and understand data and progressively refine models.

Models generated by the learning engine 227 can be stored in the model database 230. As illustrated in FIG. 2, the model database 230 may be included in the memory 205 of the server 110. It should be understood, however, that, in some configurations, the model database 230 may be included in one or more separate devices accessible by the server 110 of FIG. 1 (including a remote database, and the like).

In some configurations, the technology disclosed herein may utilize or implement one or more large language models (LLMs) as part of implementing the TMS processes and functionality described herein. Accordingly, in some configurations, the learning engine 227 may develop one or more LLMs 235. Generally, a LLM 235 may include a deep AI or machine learning model that can comprehend and generate human language text. For instance, a LLM 235 may be configured to determine meanings (or context) from a sequence of words and understand relationships between those words and, ultimately, perform a task based on that understanding. For instance, a LLM 235 may perform a variety of natural language processing (“NLP”) related tasks to produce content based on input prompts in human language. Such tasks may generally include answering questions (e.g., responding to a user query), translating text, text generation, content summary, sentiment analysis, etc.

The LLM(s) 235 may be an artificial neural network that is trained using self-supervised learning, semi-supervised learning, or a combination thereof. Accordingly, in some configurations, the learning engine 227 may develop artificial neural networks using self-supervised learning, semi-supervised learning, or a combination thereof. As illustrated in FIG. 2, the LLM(s) 235 may be stored in the model database 230 of the server 110. It should be understood, however, that, in some configurations, the LLM(s) 235 may be included in one or more separate devices accessible by the server 110 of FIG. 1 (including a remote database, and the like). In some configurations, the LLM(s) 235 may be trained (or retrained) using feedback data (as training data).

Alternatively, or in addition, in some configurations, the AI system 225 may include one or more AI agents 260. In some instances, the AI agents 260 may utilize (or otherwise implement) one or more machine learning models developed by the learning engine 227 (e.g., the LLM(s) 235). As described in greater detail herein, the AI agent(s) 260 may be a software agent that monitors various aspects (or environments) of the TMS platform 112. In some instances, the AI agent(s) 260 may execute (or otherwise perform) tasks or actions autonomously based on the monitoring of the TMS platform 112, as described in greater detail herein.

As one example, the AI agent(s) 260 may monitor communications exchanged between users and autonomously permit or limit the exchange of communication including blocked content, as described in greater detail herein. As another example, the AI agent(s) 260 may monitor information related to a vehicle transportation order, determine a present status (or changes thereto) based on the monitored information, and autonomously update one or more user interfaces described herein to represent a present status of the vehicle transportation order, as described in greater detail herein. As yet another example, the AI agent(s) 260 may monitor communications between a first user and a second user, detect when a first user is unresponsive to a communication (or message) from a second user, and autonomously execute an automated action (e.g., providing a follow-up message to the unresponsive user, alerting a TMS user, etc.), as described in greater detail herein.

As yet another example, the AI agent(s) 260 may monitor communications exchanged within an order-specific user interface (e.g., a user interface that is specific to a particular vehicle transportation order) for communications unrelated to the vehicle transportation order specific to that order-specific user interface. Following this example, when the AI agent(s) 260 detect communications related to another, different vehicle transportation order (or attempts thereof), the AI agent(s) 260 may prevent the unrelated communications from occurring within the order-specific user interface, redirect the unrelated to an existing order-specific user interface for the other vehicle transportation order, generate (or otherwise create) an order-specific user interface for the other vehicle transportation order, etc., as described in greater detail herein.

In some configurations, the AI agent(s) 260 may execute functionality using one or more of the LLMs 235. For instance, in some examples, to perform monitoring functionality, the AI agent(s) 260 may provide, to the LLM(s) 235, input (e.g., exchanged communication or messages), a previous conversation history (or context), information regarding the vehicle transportation order, and a prompt to check for blocked content, unrelated input, etc. The LLM(s) 235 may generate a response to the prompt, identify, based on the response whether an action should be taken (e.g., an automated action), etc. In some instances, the LLM(s) 235 may also have access to the database(s) 115 (e.g., the transportation data 155 therein) such that the LLM(s) 235 may have access to information about the vehicle transportation order.

The memory 205 may include additional, different, or fewer components in different configurations. Alternatively, or in addition, in some configurations, one or more components of the memory 205 may be combined into a single component, distributed among multiple components, or the like. Alternatively, or in addition, in some configurations, one or more components of the memory 205 may be stored remotely from the server 110, or, in a remote database, another server, a remote user device, an external storage device, or the like (e.g., the database(s) 115, the TMS user device(s) 117, the transporter user device(s) 122, the shipper user device(s) 132, etc.).

Returning to FIG. 1, the TMS platform 112 may include the database(s) 115. The database(s) 115 can include any suitable storage device or devices that can be used to store suitable data. Although not illustrated in FIG. 1, the database(s) 115 may include similar components as the server 110, such as electronic processor (for example, a microprocessor, an ASIC, or another suitable electronic device), a memory (for example, a non-transitory, computer-readable storage medium), a communication interface, such as a transceiver, for communicating over the communication network 140 and, optionally, one or more additional communication networks or connections, and one or more human machine interfaces.

As illustrated in FIG. 1, the database(s) 115 may store transportation data 155. The transportation data 155 may include data or information related to performing one or more TMS processes or functionality associated with the TMS platform 112. In some examples, the transportation data 155 may include load identifier(s), preorder(s), order(s), transport vehicle (or truck) information, driver information, internal transporter information, automation rule template(s), system integration template(s), etc., that can be used, e.g., by the server 110 to receive load identifier(s), provide internal transporter indication(s), receive user input(s) to select a selected transporter indication, generate preorder(s), determine and provide group(s) based on load identifiers, generate order(s), output order(s) to internal transporter(s), determine partner transporter(s), display statuses of orders, obtain statuses of orders from the open marketplace system, generate transportation task(s), configure automation rule template(s), or configure system integration template(s).

In some configurations, the transportation data 155 may be a collection of data aggregated from a plurality of data sources, such as, e.g., the shipper user device(s) 132, the transporter user device(s) 122, another data source, etc. For example, the transportation data 155 may be compiled (or aggregated) from transportation transactions, user activity or interactions with the TMS platform 112, transport quotes, data sources external to the TMS platform 112 (e.g., external websites), external transporter data sources, communications within the TMS platform 112, navigation systems (e.g., location data, such as GPS data), data sources internal to the TMS platform 112, etc.

In some examples, the transportation data 155 may include one or more content permissions. A content permission may establish or otherwise define what content (or topics thereof) is allowed or not allowed to be communicated within the TMS platform 112. Content (or topics thereof) that are not allowed to be communicated within the TMS platform 112 may be referred to herein as “blocked content” or a “blocked topic.” For instance, as described in greater detail herein, in some examples, the technology disclosed herein provides user interfaces that allow users of the TMS platform 112 to communicate with each other. For example, a shipper 130 and a transporter 120 may communicate directly with each other via one or more user interfaces described in greater detail herein. In some instances, it may be advantageous to prevent (or otherwise block) various types of communication from occurring. As one specific example, it may be advantageous to prevent a shipper 130 and a transporter 120 from discussing topics related to payout information, side job information, margins, etc. Accordingly, in some configurations, the transportation data 155 may include data or information that indicates blocked content (or indicates how to identify or detect blocked content).

In some examples, the transportation data 155 may include one or more user permissions. As used herein, a user permission may define accessibility to data (e.g., TMS data) or content (e.g., electronic or digital content). In some examples, the user permission(s) may specify what content a user may access or interact with (e.g., view, edit, download, etc.). In some configurations, the user permission(s) may be based on a specific user (e.g., user-specific user permissions). For instance, a first user may have a first user permission while a second user may have a second user permission different from the first user permission. In some examples, the user permission(s) may be based on a role or title of a user, a department or group of a user, etc. As one example, the transporter(s) 120 may have different user permissions than the shipper(s) 130. As another example, a TMS user may have a different user permission than the shipper(s) 130, the transporter(s) 120, or a combination thereof.

Alternatively, or in addition, the transportation data 155 may include transporter data. As described herein, the transporter(s) 120 may include, e.g., a driver, a company user, or a suitable person to perform vehicle transportation operations. In some examples, transporter data may include information or data related to, e.g., a type of the transporter 120 (e.g., an inhouse transporter, a partner transporter, an open marketplace transporter, etc.), a name of the transporter 120; a type of the transport vehicle(s) 124 of the transporter 120 (e.g., a single-level trailer, a multi-level trailer, a single-car trailer, a multi-car trailer, an enclosed trailer, an open car trailer, a flatbed trailer, a freight truck, an auto carrier, a semi-trailer, an enclosed multi-level car carrier, etc.); a number of transport vehicle(s) 124 in a fleet of the transporter 120; an availability or status of the transport vehicle(s) 124; an availability or status of the transporter 120 (e.g., awaiting transport, active or in transit, inactive, down for maintenance, etc.); location related information (e.g., a location that the transporter 120 is based out of, a location of the transport vehicle(s) 124, a current location of the transport vehicle(s) 124 or the transporter 120, a future location of the transport vehicle(s) 124 or the transporter 120, etc.); contact information (e.g., an email address, a mailing address, a phone number, a fax number, etc.); a preference of the transporter 120 (e.g., whether the transporter 120 will deliver in urban or high density areas, etc.); a TMS account identifier of the transporter 120 (e.g., credentials for the TMS platform 112, such as an account number, a username, etc.); order related information for the transporter 120 (e.g., a number of completed orders, a number of pending orders, an order satisfaction rating or metric, etc.); usage data related to the TMS platform 112 (e.g., how frequently does the transporter 120 interact or use the TMS platform 112, how responsive is the transporter 120 to communications within the TMS platform 112, etc.); payout information (e.g., average payout per order, a minimum payout, a maximum payout, etc.); a statistic related to previous orders (e.g., a characteristic or parameter of previously transported vehicles, a list of shippers that the transporter 120 has previously transported for, previous routes, previous destinations, a delayed delivery metric, etc.); experience of the transporter 120 (e.g., how long the transporter 120 has been transporting vehicles); a permission of the transporter, such as, e.g., a certificate, a permit, a registration, a credential, or a license of the transporter 120 (e.g., a USDOT number, a commercial driver's license, a proof of insurance, an oversized permit, an overweight permit, a state-specific permit, a heavy vehicle use permit, a state motor carrier permit or registration, etc.); etc.

Alternatively, or in addition, the transportation data 155 may include order information. The order information can include one or more load identifiers. In some examples, a load identifier can be any suitable indication (e.g., vehicle identification number or any other suitable indication) to identify a load (also referred to herein as a transportation order). In some examples, the load identifier is associated with load transportation information (e.g., pickup information (e.g., a pickup location or starting location, an estimated pickup time, pickup driver contact information, a pickup note, etc.), drop-off information (e.g., a drop-off location or destination, an estimated drop-off time, drop-off driver contact information, a drop-off note, etc.), a real-time location of the load(s), a distance between the pickup location and the drop-off location, or any other suitable information associated with the one or more loads to transport). In other examples, the load identifier can include the load transportation information as well. In further examples, the order information can further include an order status, or any other suitable information related to the order. In some examples, the order status can include an available status (e.g., with an assigned driver), an unassigned status (e.g., without an assigned driver), an unclaimed status (e.g., the order before being accepted by the assigned transporter), or any other suitable status.

Alternatively, or in addition, the transportation data 155 can include preorder information. In some examples, a preorder indicates an order without an assigned transporter. The preorder information can include one or more load identifiers, load transportation information corresponding to the one or more load identifiers (e.g., pickup information (e.g., a pickup location, an estimated pickup time, a pickup note, etc.), drop-off information (e.g., a drop-off location, an estimated drop-off time, a drop-off note, etc.), a distance between the pickup location and the drop-off location), and any other suitable information related to the preorder.

Alternatively, or in addition, the transportation data 155 can include location information. The location information can show the pickup location, the drop-off location of the order, or a route between the pickup location and the drop-off location on a map. In further examples, the location information can further show a current location of the load(s) and a traveled route of the load(s) on a map. In some examples, the current location of the load(s) can be tracked by a location sensor in, e.g., the transporter user device(s) 122.

Alternatively, or in addition, the transportation data 155 may include status information. The status information can show an order timeline and where the order is located in the timeline. For examples, the order timeline can include one or more fixed status points (e.g., new order, transporter accept, in transit, delivered, and completed).

Alternatively, or in addition, the transportation data 155 may include activity information. The activity information can show each activity with/without a time of the occurring activity related to the order. For example, the activity information can show when the order is generated, when load(s) is ready for pickup, when the order is output to the transporter or the open marketplace system, when a transportation task message or notification is sent to the user, when load(s) is delivered, when the order is completed, and/or when any other suitable transportation operation is performed.

As noted herein, the TMS user(s) may be associated the TMS user device(s) 117, the transporter(s) 120 may be associated with the transporter user device(s) 122, and the shipper(s) 130 may be associated with the shipper user device(s) 132. The TMS user device(s) 117, the transport user device(s) 122, and the shipper user device(s) 132 may include a computing device, such as, e.g., a desktop computer, a laptop computer, a tablet computer, a terminal, a smart telephone, a smart television, a smart wearable, or another suitable computing device that interfaces with a user. Although not illustrated in FIG. 1, the TMS user device(s) 117, the transport user device(s) 122, and the shipper user device(s) 132 may include similar components as the server 110, such as electronic processor (for example, a microprocessor, an ASIC, or another suitable electronic device), a memory (for example, a non-transitory, computer-readable storage medium), a communication interface, such as a transceiver, for communicating over the communication network 140 and, optionally, one or more additional communication networks or connections. For example, to communicate with the TMS platform 112 (e.g., the application 220 of the server 110), the TMS user device(s) 117, the transport user device(s) 122, and the shipper user device(s) 132 may store a browser application or a dedicated software application executable by an electronic processor (or processing system that includes one or more electronic processors). In some configurations, the TMS user device(s) 117, the transport user device(s) 122, and the shipper user device(s) 132 may include additional, fewer, or different components than the server 110. For example, as illustrated in FIG. 1, in some configurations, that TMS user device(s) 117, the transport user device(s) 122, and the shipper user device(s) 132 include a human-machine interface (HMI) 180. The HMI 180 may include one or more input mechanisms (e.g., a keyboard or keypad, one or more buttons, a microphone, or the like) or output mechanisms (e.g., a display device, a speaker, or the like) that allow a user to interact with that TMS user device(s) 117, the transport user device(s) 122, or the shipper user device(s) 132. For example, as illustrated in FIG. 1, the HMI 180 may include a display device 185, such as a screen, a monitor, a hologram, a touchscreen, etc.

The system 100 is described herein as providing a TMS service through the server 110. For instance, as noted herein, the server 110 may implement (or host) a TMS (e.g., via the TMS platform 112) such that the server 110 may provide (or host) a TMS service or related functionality to, e.g., the TMS user device(s) 117, the transport user device(s) 122, the shipper user device(s) 132, or a combination thereof. However, in other configurations, the functionality described herein as being performed by the server 110 may be locally performed by, e.g., the TMS user device(s) 117, the transport user device(s) 122, the shipper user device(s) 132, or a combination thereof. For example, in some configurations, the TMS user device(s) 117, the transport user device(s) 122, the shipper user device(s) 132, or a combination thereof may store one or more components described herein as being stored in the memory 205 of the server 110 (e.g., the application 220, the AI system 225, the learning engine 227, the model database 230, the LLM(s) 235, the AI agent(s) 260, etc.).

The TMS users, the shipper(s) 120, or the transporter(s) 120 may use the TMS user device(s) 117, the shipper user device(s) 132, or the transporter user device(s) 122, respectively, to interact with the TMS platform 112. For example, the shipper(s) 120 may use the shipper user device(s) 132 to access the TMS platform 112 to, e.g., create a transportation order for a vehicle to be transported, check a status of an existing transportation order, communicate with a transporter of an existing transportation order, etc. The transporter(s) 120 may use the transporter user device(s) 122 to access the TMS platform 112 to, e.g., view a published or pending transportation order, view payout information for a transportation order, claim a published or pending transportation order (e.g., a preorder), communication with a shipper of a transportation order claimed by the transporter 120, provide transportation load identifier(s), provide transporter information (e.g., the transporter data described herein), assign drivers to the transport vehicle(s) 124, generate preorder(s), generate order(s), group preorders, group orders, output order(s) to an internal transporter, an open marketplace system, etc. The TMS user may use the TMS user device(s) 117 to access the TMS platform 112 to, e.g., perform operational tasks or actions within the TMS platform 112, resolve issues or problems with respect to a vehicle transportation order, interact with (e.g., view, edit, close, etc.) a vehicle transportation order, check a status of a vehicle transportation order, respond to inquiries or communications from a shipper, a transporter, or a combination thereof, etc.

In some configurations, the transporter user device(s) 122 may be carried by a driver and correspond to or be assigned to a particular transport vehicle 124. In such configurations, the transporter user device(s) 122 may automatically generate or update the transporter data described herein (e.g., the transportation data 155). For example, the transporter user device(s) 122 may provide and update a transportation order status (e.g., available to perform an order, ready to pick up load(s), arriving at a pick-up location, moving to a drop-off location, arriving at a drop-off location, completing an order, etc. As another example, the transporter user device(s) 122 may be coupled with a location tracking device (e.g., a GPS device or the like) to provide location information of the transport vehicle 124 (or the driver thereof).

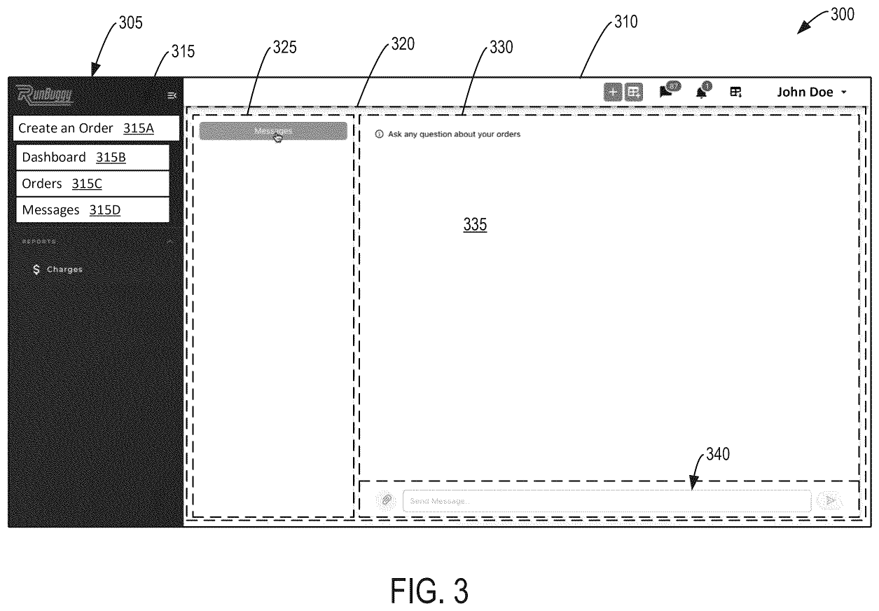

FIG. 3 is a screenshot of an example TMS user interface (UI) 300 in accordance with some configurations herein. In some instances, the TMS UI 300 may be a graphical user interface (GUI). In some instances, the server 110 (e.g., via implementation of the TMS) may generate the TMS UI 300 to be displayed (via respective display devices 185) on the TMS user device(s) 117, the transporter user device(s) 122, or the shipper user device(s) 132. The TMS user(s), the transporter(s) 120, the shipper(s) 130, or a combination thereof may interact with the TMS UI 300 via, e.g., respective HMIs 180.

As illustrated in FIG. 3, the TMS UI 300 may include a menu portion 305 and a content portion 310. The menu portion 305 may include one or more navigation elements 315. The navigation element(s) 315 may control navigation among various content interfaces (or UIs). For instance, the navigation element(s) 315 may control the content (e.g., information or data) displayed in the content portion 310. In the example of FIG. 3, the navigation element(s) 315 may include a Create an Order element 315A, a Dashboard element 315B, an Orders element 315C, a Messages element 315D, etc. Based on which navigation element 315 is selected, the content portion 310 may include content related to the selected navigation element 315, where that content may be specific to a particular user (e.g., a particular TMS user, a particular shipper 130, a particular transporter 120, etc.).

For instance, as illustrated in FIG. 3, the content portion 310 may provide content related to messaging functionality of the TMS via a messages interface 320. In some configurations, a user may interact with the messages interface 320 in order to interact with various aspects or functionality of the TMS. As one example, a shipper 130 or a transporter 120 may interact with the messages interface 320 by providing a question or inquiry regarding the TMS, including, e.g., a vehicle transportation order, how to perform an action or task within the TMS, etc. In some examples, the question or inquiry may be provided to a TMS user via the TMS user device(s) 117, the AI system 225, etc. The TMS user, the AI system 225 (e.g., the AI agent(s) 260, the LLM(s) 235, etc.), or a combination thereof may take an action with respect to the question. As one example, the TMS user, the AI system 225, or a combination thereof may provide an answer that responds to the question.

In the example of FIG. 3, the messages interface 320 may include a messages panel 325 and a messaging portion 330. The messages panel 325 may include a listing of messages, including, e.g., existing messages, previous messages, active messages, etc. The messaging portion 330 may facilitate the exchange of messages between the user(s). The messaging portion 330 may include a conversation portion 335 and an input portion 340. The conversation portion 335 may provide a conversation history or summary messages exchanged between the user(s). The input portion 340 may include an input element that receives user input from a user, such as, e.g., a text string, an attachment, a picture, etc.

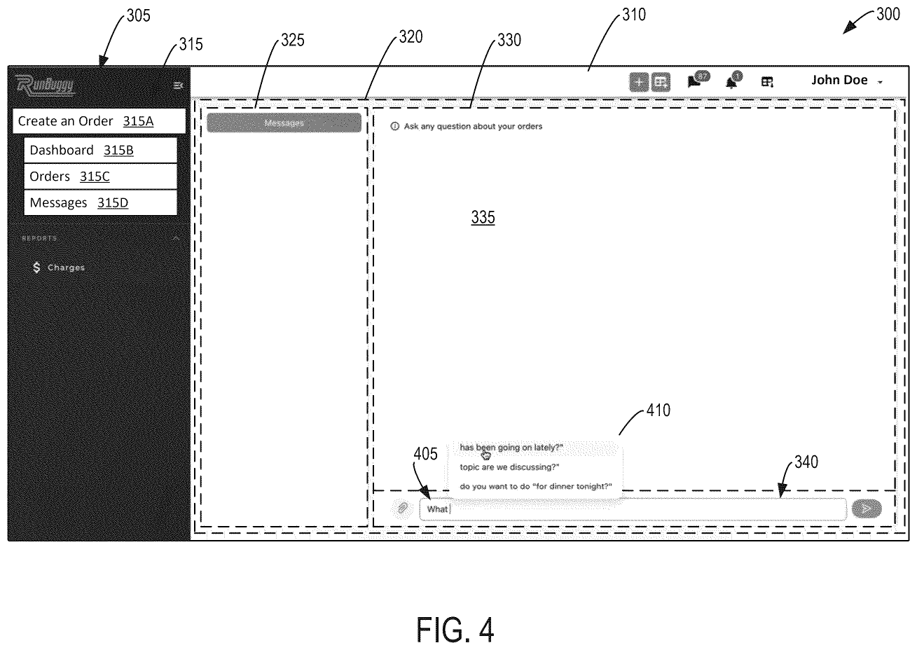

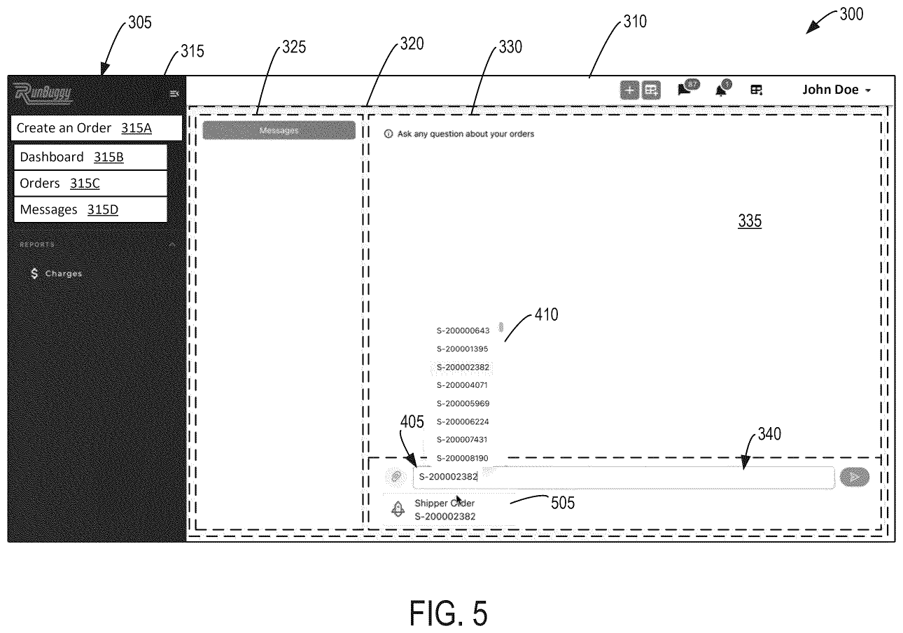

For instance, as illustrated in FIG. 4, a user may input a user query (or message) via the input portion 340 (represented by reference numeral 405). In some configurations, as illustrated in FIG. 4, a user may be prompted suggestions via a suggestions prompt 410. The suggestions prompt 410 (or the suggestion(s) thereof) may be generated (or otherwise determined) using the AI system 225, such as, e.g., the AI agent(s) 260, the LLM(s) 235, or a combination thereof. In some instances, the suggestions prompt 410 may provide a prediction of what the user input may be (as the suggestion). In some instances, the suggestions prompt 410 may include one or more predicted text inputs, as illustrated in FIG. 4. Alternatively, or in addition, as illustrated in FIG. 5, the suggestions prompt 410 may include one or more predicted entities or objects related to the TMS. An entity (or object) may include, e.g., an order number, a shipper identification, a transporter identification, an account identifier, an order status, a pick-up location name, a destination name, a pick-up location address, a destination address, identifying information for a particular user (e.g., a name, an email, an address, a phone number, etc.), etc. In the example of FIG. 5, the suggestions prompt 410 may include a predicted order number (e.g., order number “S-200002382” in the illustrated example of FIG. 5). In some instances, when the suggestion involves electronic content (e.g., an electronic document, a vehicle transportation order, etc.), the electronic content may be attached to the message (represented in FIG. 5 by reference number 505). After submitting the user query via the input portion 340, a preview of the user query may be provided within the conversation portion 335. A response to the user query may be provided within the conversation portion 335, such as, e.g., a response message provided by a TMS user that responds to the user query.

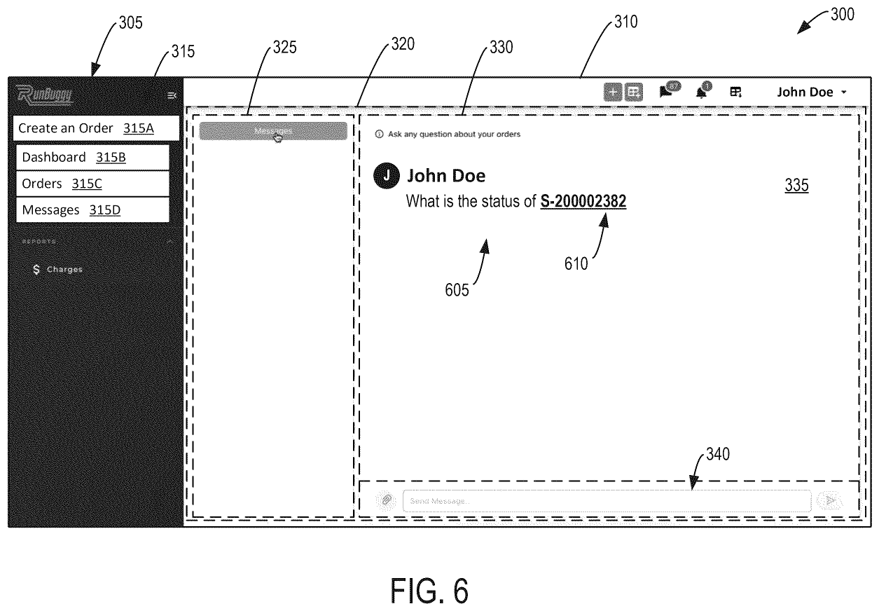

For example, as illustrated in FIG. 6, the user query may include “What is the status of S-200002382.” In some instances, when the user query includes an entity (e.g., order S-200002382 of FIG. 6), the preview of the user query may include (or otherwise provide) a link to the entity (or electronic content associated with the entity). With reference to FIG. 6, the user query includes a link 610 to the order S-200002382 such that, when a user interacts with the link 610, the user may be re-directed to an interface (or UI) specific to the order, as described in greater detail herein.

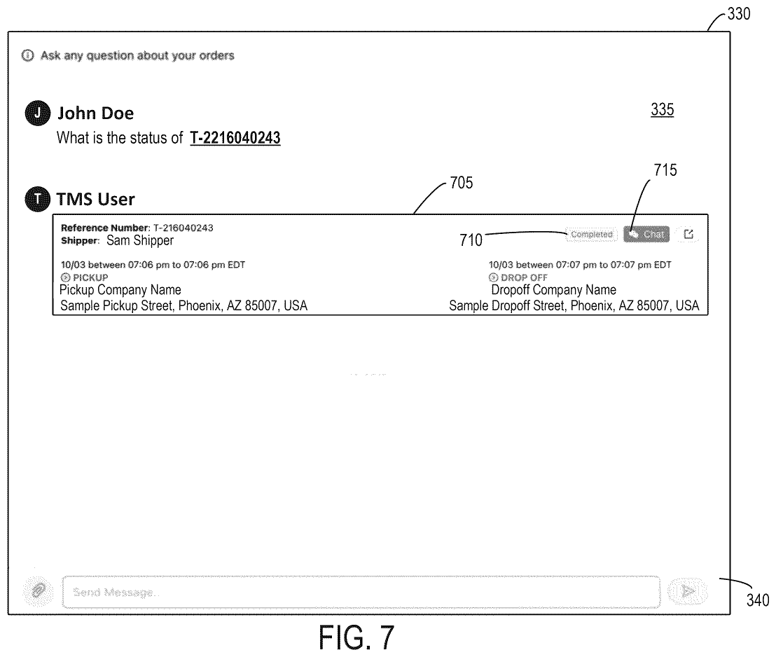

As illustrated in FIG. 7, in some instances, a response to the user query related to a specific vehicle transportation order may include an order summary 705. The order summary 705 may be provided within the messaging portion 330 of the messages interface 320. As illustrated in FIG. 7, the order summary 705 may provide information or data related to the vehicle transportation order included in the user query. For instance, in some examples, the order summary 705 may provide a status indicator 710 (or indication) of a present status for the vehicle transportation order. As described in greater detail herein, in some examples, the status indicator 710 may be dynamically updated as a status of the vehicle transportation order changes (e.g., via the AI system 225, including, e.g., the AI agent(s) 260 thereof). In some instances, the order summary 705 may include one or more interactive elements 715. The interactive element(s) 715 may include UI control elements, such as, e.g., a button. An interactive element 715 may be related to an action available to be performed on the vehicle transportation order, as described in greater detail herein. In the example of FIG. 7, the order summary 705 may include an interactive element 715 that may relate to facilitating communications with respect to the vehicle transportation order. As described in greater detail herein, in some instances, communications related to the vehicle transportation order may be facilitated via an order-specific user interface. Accordingly, in some configurations, responsive to a user interaction with the interactive element 715 of FIG. 7 (e.g., the chat button), an order-specific UI may be provided to a user, as described in greater detail herein.

An order-specific UI may be an integration (or combination) of a messaging (or communication) interface and an order interface such that a user may interact with an order and communicate regarding that order within a single integrated interface (as opposed to separate discrete interfaces, such as a separate order interface and a separate messaging interface). For instance, an order-specific UI may be specific to a particular vehicle transportation order such that order information presented and communications exchanged via the order-specific UI is limited (or otherwise restricted to) that particular vehicle transportation order. For instance, when the order-specific UI is specific to a first vehicle transportation order, information or communications related to a second, different vehicle transportation order will be excluded from the order-specific UI. As such, using the technology disclosed herein, a user does not have to leave an order-specific interface to, e.g., interact with another user about that specific order. Rather all functionality available for an order may be performed within the order-specific interface (as opposed to discrete interfaces). For instance, a shipper is able to interact with an order using a single conversational interface that is order specific such that the shipper may see, e.g., order history, order status, order conversation(s), etc. within a single interface.

In some examples, an order-specific UI may be linked to one or more users associated with the vehicle transportation order that is specific to the order-specific UI. For example, a vehicle transportation order may be associated with a shipper, a transporter, and a TMS user (e.g., a TMS representative assigned to overseeing the vehicle transportation order). Following this example, an order-specific UI specific to that vehicle transportation order may be linked (or otherwise associated with) the shipper, the transporter, and the TMS user. In some instances, the order-specific UI may be accessible by the users linked to the vehicle transportation order (or the order-specific UI). In some examples, the order-specific UI may be inaccessible to users not linked to the vehicle transportation order (or the order-specific UI).

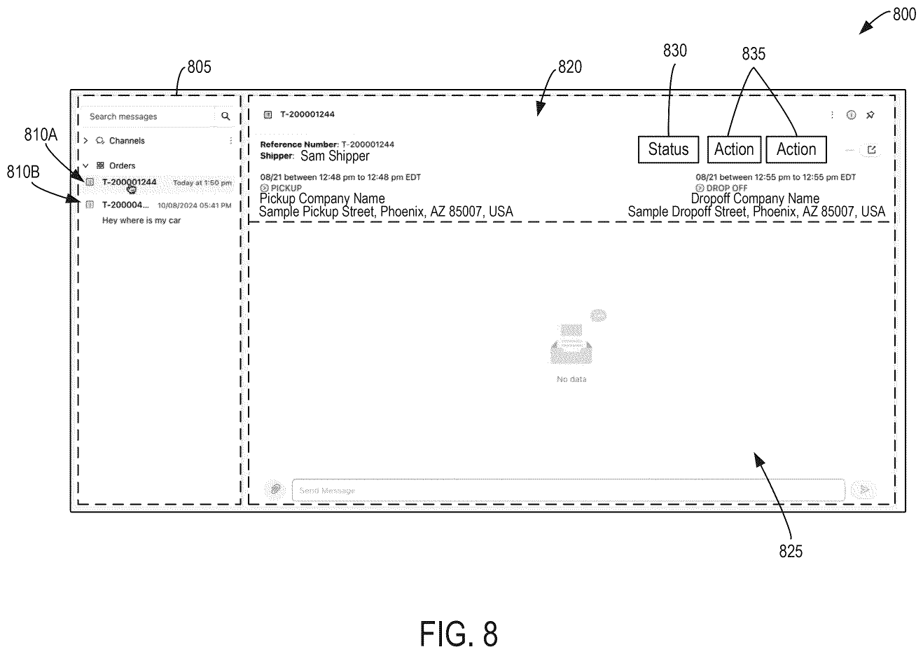

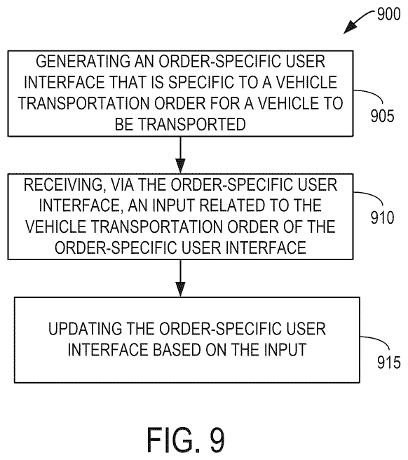

FIG. 8 illustrates an example order-specific UI 800 in accordance with some configurations. Functionality related to the order-specific UI 800 is described in greater detail herein, such as, e.g., with respect to FIG. 9. In some examples, the order-specific UI 800 may be included within the TMS UI 300, such as, e.g., within the content portion 310 of the TMS UI 300.

In some configurations, the order-specific UI 800 may include a channel portion 805. The channel portion 805 may include a list of one or more channels associated with a user (e.g., the shipper(s) 130, the transporter(s) 120, etc.). A channel may represent a dedicated space or grouping in which content may be organized, such as, e.g., for a particular vehicle transportation order. For instance, a channel included in the channel portion 805 may be associated with a particular vehicle transportation order. For example, as illustrated in FIG. 8, the channel portion 805 may include a first channel 810A associated with a first vehicle transportation order and a second channel 810B associated with a second vehicle transportation order.

In some configurations, the electronic processor 200 may dynamically update (or manage) a sequence or order in which channels are displayed within the channel portion 805. For example, in some instances, the list of channels included in the channel portion 805 may be a ranked list. The channels may be ranked based on a priority ranking, such that, e.g., a higher priority channel (or vehicle transportation order thereof) is positioned higher than a lower priority channel (or vehicle transportation order thereof). Alternatively, or in addition, in some instances, the channels may be ranked based on a temporal metric (e.g., time since last update or change made to the vehicle transportation order), such that, e.g., a most recently updated vehicle transportation order may be positioned at the top of the list of channels. Accordingly, in some instances, the electronic processor 200 (e.g., the AI agent(s) 260) may monitor information or data related to the vehicle transportation orders and, in some instances, control a sequence or order in which channels are displayed within the channel portion 805 (e.g., based on updates or changes to the vehicle transportation orders). Alternatively, or in addition, in some instances, the electronic processor 200 may dynamically update (or control) the sequence or order based on a user setting or preference. For example, when a user marks a vehicle transportation order as a high priority order or “an order to be watched,” the electronic processor 200 may place (or otherwise position) the vehicle transportation order (or the representative channel thereof) accordingly in the channel portion 805.

In some examples, the list of channels in the channel portion 805 may include vehicle transportation orders that may actively involve the attention of a user (e.g., a shipper's attention). For instance, the orders represented in the channel portion 805 (e.g., as respective channels) may include vehicle transportation orders that involve, e.g., an updated order status, an uncompleted task to be performed, a high order risk, a pending inquiry or question, etc. In some instances, the orders represented in the channel portion 805 may be displayed with an indication of when the latest status update occurred, a priority ranking, an order risk, or another characteristic for the vehicle transportation order.

As such, the channel portion 805 may provide a consolidated (or condensed) view for a user (e.g., the shipper 130, the transporter 120, etc.), such that the user may focus attention on orders with issues or changes (or orders that need attention).

The order-specific UI 800 may include an order information portion 820 and an order communication portion 825. The order information portion 820 may indicate information related to a vehicle transportation order of the order-specific UI 800. In the example, of FIG. 8, the order information portion 820 may include information related to order T-200001244. As illustrated in the example of FIG. 8, in some instances, the order information portion 820 may include a status indicator (or indication) 830 (e.g., the status indicator 710 of FIG. 7) for order T-200001244. As noted herein, the status indicator 830 may represent a present status of the vehicle transportation order specific to the order-specific UI 800. The order information portion 820 may include one or more interactive elements 835 (e.g., the interactive element 715 of FIG. 7) associated with performance (or execution) of a corresponding action available for the vehicle transportation order of the order-specific UI 800. The order communication portion 825 may receive input (and provide output) related to vehicle transportation, such as, e.g., input related to the vehicle transportation order of the order-specific UI 800. In some instances, the order communication portion 825 may receive input (and provide output) as described herein with respect to the messages interface 320 of FIGS. 3-7. In some instances, the order information portion 820 may be maintained at a top portion of the order-specific UI 800 and the order communication portion 825 may be provided below the order information portion 820 of the order-specific UI 800.

As noted herein, the system 100 may facilitate (or otherwise provide) one or more TMS processes or functionality, as described herein. In some configurations, the technology disclosed herein relates to an implementation of artificial intelligence (AI) integrated logistics systems and methods for implementation within an electronic transportation management system (TMS), and, in particular, to an AI-integrated order-specific interface that advantageously improves electronic communication and automated operational task management within the TMS.

FIG. 9 is a flowchart illustrating an example method 900 to control communications within the TMS platform 112 using an AI-integrated order-specific interface (e.g., the order-specific UI 800 of FIG. 8) in accordance with some configurations. The method 900 is described as being performed by the server 110 and, in particular, the application 220 as executed by the electronic processor 200. However, as noted above, the functionality described with respect to the method 900 may be performed by other devices, such as, e.g., the TMS user device(s) 117, the transporter user device(s) 122, or the shipper user device(s) 132, or distributed among a plurality of devices, such as a plurality of servers included in a cloud service. Additionally, as one example, the method 900 is described with reference to the order-specific UI 800 of FIG. 8. However, the method 900 may be implemented with respect to other examples of order-specific UIs, and the order-specific UI 800 of FIG. 8 is just one example of such an order-specific UI.

As illustrated in FIG. 9, the method 900 may include generating, with the electronic processor 200, an order-specific user interface (e.g., the order-specific UI 800) that is specific to a vehicle transportation order for a vehicle to be transported (e.g., the vehicle(s) 136) (at block 905). As noted herein, the order-specific UI 800 may include the order information portion 820, to indicate information related to the vehicle transportation order of the order-specific UI 800. The order-specific UI 800 may include the order communication portion 825, to receive input (or provide output) related to vehicle transportation (e.g., the vehicle transportation order of the order-specific UI 800).

In some configurations, the electronic processor 200 may utilize the AI system 225 to generate the order-specific UI 800. For instance, in some examples, the electronic processor 200 may utilize the AI agent(s) 260 to generate the order-specific UI 800. As one example, the AI agent(s) 260 may monitor events (or information) related to a vehicle transportation order and determine, based on the monitored events (or information), whether to generate an order-specific UI for that vehicle transportation order (or update an existing order-specific UI for that vehicle transportation order).

As one example, when the AI agent(s) 260 detect a change related to the vehicle transportation order, the AI agent(s) 260 (or the electronic processor 200) may generate (or otherwise update) an order-specific UI for the vehicle transportation order. Such a change may include, e.g., a change to a status of the vehicle transportation order, an alert related to the vehicle transportation order, a cancelation of the vehicle transportation order, etc. As another example, when the AI agent(s) 260 detect a user query related to a vehicle transportation order (e.g., input of a user query (or message) via the input portion 340 of FIGS. 3-7, where the user query (or message) mentions or is related to the vehicle transportation order), the AI agent(s) 260 (or the electronic processor 200) may generate (or otherwise update) an order-specific UI for the vehicle transportation order. As yet another example, when the AI agent(s) 260 detect a user interaction with a chat button associated with a vehicle transportation order (e.g., the interactive element 715 of FIG. 7), the AI agent(s) 260 (or the electronic processor 200) may generate (or otherwise update) an order-specific UI for the vehicle transportation order. As still another example, when the AI agent(s) 260 detect an attempt to submit a user query related to a first vehicle transportation order in an order-specific UI for a second vehicle transportation order, the AI agent(s) 260 (or the electronic processor 200) may generate (or otherwise update) an order-specific UI for the first vehicle transportation order

The electronic processor 200 may receive, via the order-specific UI 800, an input related to the vehicle transportation order of the order-specific UI 800 (at block 910). Responsive to receipt of the input, the electronic processor 200 may update the order-specific UI 800 based on the input (at block 915).

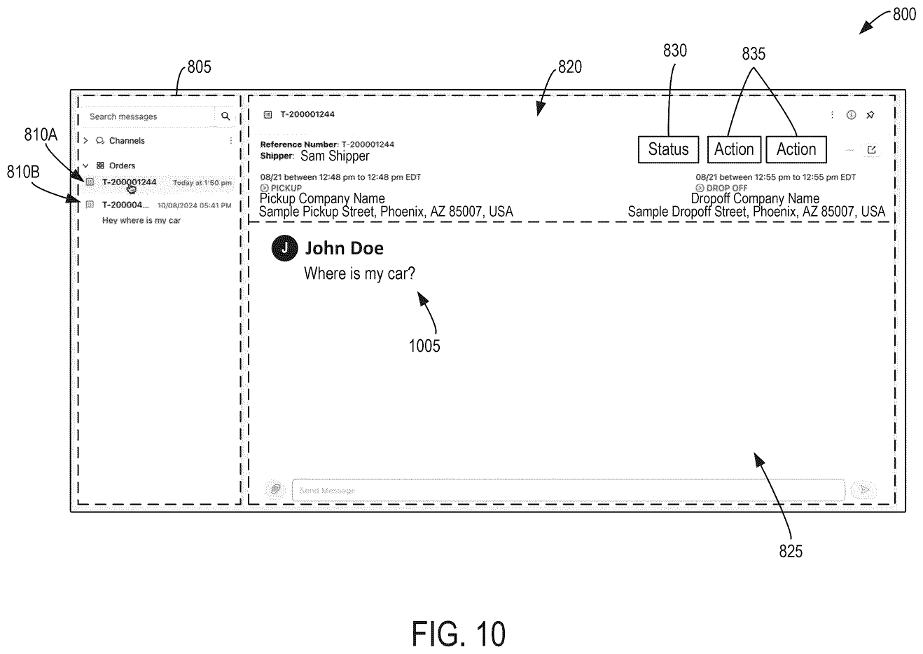

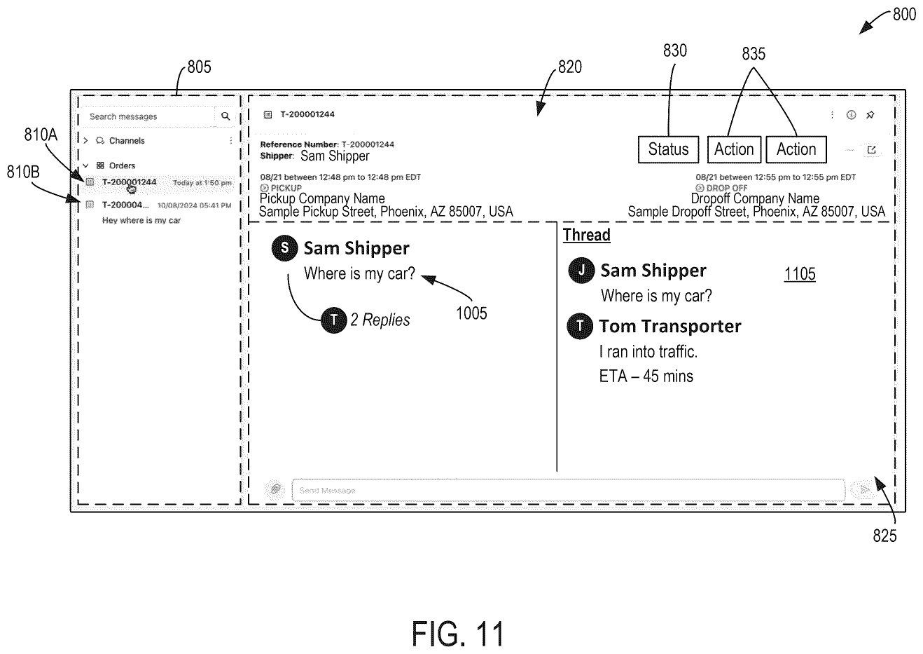

In some instances, the input may be an inquiry or question related to the vehicle transportation order of the order-specific UI 800. For example, as illustrated in FIG. 10, the input may include “Where is my car?” (represented in FIG. 10 by reference numeral 1005). The input may be directed to another user linked to the vehicle transportation order, such as, e.g., a shipper, a transporter, or a TMS user. As illustrated in FIG. 11, in some instances, the order-specific UI 800 may facilitate various threads or threaded conversations (represented in FIG. 11 by reference numeral 1105). As illustrated in FIG. 10, the electronic processor 200 may update the order-specific UI 800 such that the input (e.g., “Where is my car?”) is included in the order communication portion 825 of the order-specific UI 800.

In some instances, the input may be a request or action to be performed (or executed) with respect to the vehicle transportation order. In some examples, responsive to receiving an input related to a request or action to be performed (or executed) with respect to the vehicle transportation order, the electronic processor 200 (e.g., the AI agent(s) 260) may perform (or execute) the requested action (e.g., as an automated action for the vehicle transportation order). In some configurations, the electronic processor 200 (e.g., the AI agent(s) 260) may update the order-specific UI 800 by performing (or executing) the requested action (e.g., such as where performance of the requested action results in an update to information provided via the order-specific UI 800).

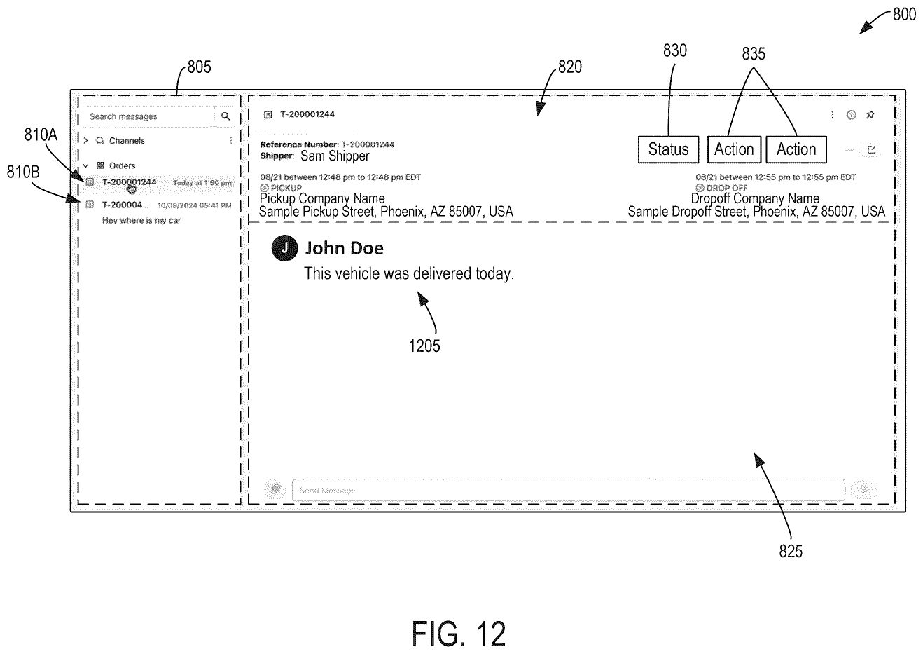

For example, as illustrated in FIG. 12, in some instances, the input may be related to a status for the vehicle transportation order (represented in FIG. 12 by reference numeral 1205). In some instances, the input may be a direct request to perform an action or task related to the vehicle transportation order (e.g., “Change status to complete.”). Alternatively, or in addition, in some instances, the input may be an indirect request to perform an action or task related to the vehicle transportation order (e.g., may imply or indicate that an action or task should be performed related to the vehicle transportation order). With respect to the example of FIG. 12, the input “This vehicle was delivered today.” may imply (or otherwise suggest) that the status of the vehicle transportation order should be updated to a “Completed” status. In some examples, the electronic processor 200 may use the AI agent(s) 260 to determine whether an input involves a request to perform (or execute) an action with respect to the vehicle transportation order.

In some instances, the electronic processor 200 (e.g., the AI agent(s) 260) may monitor the exchange of communication via the order-specific UI 800 to ensure that the users are responsive to each other. For instance, the electronic processor 200 (e.g., the AI agent(s) 260) may monitor an amount of time since receipt of an input without a response from a target recipient of the input. When the amount of time exceeds a threshold (e.g., a trigger condition), the electronic processor 200 (e.g., the AI agent(s) 260) may generate an alert indicating that the target recipient is unresponsive (e.g., as an automated action). In some instances, the electronic processor 200 (e.g., the AI agent(s) 260) may provide the alert to a TMS user (e.g., the TMS user device(s) 117), the target recipient (e.g., the TMS user device(s) 117, the shipper user device(s) 132, or the transporter user device(s) 122), etc. In some instances, the electronic processor 200 (e.g., the AI agent(s) 260 may attempt to contact the target recipient using another communication method, such as, e.g., a direct phone call, a text message, an email, etc.

In some configurations, the electronic processor 200 (e.g., the AI agent(s) 260) may monitor the exchange of communication via the order-specific UI 800. For instance, the electronic processor 200 (e.g., the AI agent(s) 260) may utilize a content permission of the transportation data 155 to determine whether to allow or prevent an exchange of communication (or messages) via the order-specific UI 800. As noted herein, a content permission may establish or otherwise define what content (or topics thereof) is allowed or not allowed to be communicated within the TMS platform 112. For instance, in some configurations, the content permission may establish one or more trigger conditions, where the trigger condition(s) may trigger, as an automated action, the blocking of content. For example, a shipper 130 and a transporter 120 that are linked to a vehicle transportation order of the order-specific UI may communicate directly with each other via the order-specific UI 800. However, as noted herein, in some instances, it may be advantageous to prevent (or otherwise block) various types of communication from occurring. As one specific example, it may be advantageous to prevent a shipper 130 and a transporter 120 from discussing topics related to payout information, side job information, margins, etc. Accordingly, in some configurations, electronic processor 200 (e.g., the AI agent(s) 260) may monitor content of input received via the order-specific UI 800 such that the exchange of blocked content via the order-specific UI 800 may be prevented.

In some instances, the electronic processor 200 (e.g., the AI agent(s) 260) may monitor the exchange of communication via the order-specific UI 800 to ensure that communication exchanged within the order-specific UI 800 is related to the vehicle transportation order of the order-specific UI 800 (as opposed to a different, unrelated vehicle transportation order). Accordingly, in some instances, the electronic processor 200 may receive, via the order-specific UI 800, an input (or a message). The electronic processor 200 (e.g., the AI agent(s) 260) may determine whether that input (or the message) is related to the vehicle transportation order that the order-specific UI 800 is specific to (e.g., as a trigger condition for an automated action). When the input is related to the vehicle transportation order of the order-specific UI 800, the electronic processor 200 (e.g., the AI agent(s) 260) may update the order-specific UI 800 based on the input (e.g., execute an action related to the vehicle transportation order of the order-specific UI 800, include the input in the order communication portion 825 of the order-specific UI 800, etc.) (e.g., as an automated action).

When the input is related to a second, different vehicle transportation order than the vehicle transportation order of the order-specific UI 800 (e.g., when the input is unrelated to the vehicle transportation order of the order-specific UI 800), the electronic processor 200 (e.g., the AI agent(s) 260) may perform an automated action with respect to the input (e.g., unrelated input). In some examples, the electronic processor 200 (e.g., the AI agent(s) 260) may prevent inclusion of the unrelated input in the order communication portion 825 of the order-specific UI 800 (e.g., prevent display of the unrelated input in the order communication portion 825). Alternatively, or in addition, in some examples, the electronic processor 200 (e.g., the AI agent(s) 260) may redirect the unrelated input to a different order-specific UI that is specific to the second vehicle transportation order (to which the unrelated input is actually related to). In some instances, the electronic processor 200 (e.g., the AI agent(s) 260) may redirect by (automatically) updating an existing order-specific UI for the second vehicle transportation order to include the input, generating an order-specific UI for the second vehicle transportation order (which may include the input), provide a notification or a prompt to the user associated with the input that the input is unrelated to the vehicle transportation order of the order-specific UI 800, etc.

As noted herein, in some instances, the status of a vehicle transportation order may be dynamic. In some configurations, the AI agent(s) 260 may monitor information or data related to the vehicle transportation (e.g., the transportation data 155) in order to dynamically update the status of the vehicle transportation order (e.g., the status indicator 830 of FIG. 8) (e.g., as an automated action) responsive to a change in status of the vehicle transportation order (e.g., a trigger condition for updating the order status). Accordingly, in some examples, the electronic processor 200 (or the AI agent(s) 260) may monitor a present status of the vehicle transportation order(s). Responsive to an update to the present status of the vehicle transportation order(s) (e.g., satisfying a trigger condition), the electronic processor 200 (or the AI agent(s) 260) may dynamically update, e.g., the order information portion 820 of the order-specific UI 800 to reflect the update to the present status of the vehicle transportation order (e.g., as an execution of an automated action).

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A system, comprising:
a processing system comprising one or more electronic processors, the processing system configured to:
generate a first user interface that is specific to a first vehicle transportation order for a vehicle to be transported, the first user interface to include:
an order information portion to indicate information related to the first vehicle transportation order; and
an order communication portion to receive input related to vehicle transportation;
receive, via the first user interface, an input related to the first vehicle transportation order; and
responsive to receipt of the input, update the first user interface based on the input related to the first vehicle transportation order.

2. The system of claim 1, wherein the first vehicle transportation order is linked to a plurality of users associated with transportation of the vehicle to be transported; and wherein the first user interface is to facilitate communication between the plurality of users linked to the first vehicle transportation order, wherein the communication is related to the first vehicle transportation order.

3. The system of claim 1, wherein the order information portion is to indicate a present status of the first vehicle transportation order.

4. The system of claim 1, wherein the processing system is to:
monitor a present status of the first vehicle transportation order; and
responsive to an update to the present status of the first vehicle transportation order, dynamically update the order information portion to reflect the update to the present status of the first vehicle transportation order.

5. The system of claim 1, wherein the order information portion is to indicate an action available to be executed with respect to the first vehicle transportation order.

6. The system of claim 5, wherein the action is indicated in the order information portion as an interactive element; and wherein, responsive to interaction with the interactive element, the processing system is to execute the action with respect to the first vehicle transportation order.

7. The system of claim 6, wherein the action relates to communication between a plurality of users linked to the first vehicle transportation order; and wherein, responsive to interaction with the interactive element, the processing system is to generate the order communication portion of the first user interface, the order communication portion to display a message related to the communication between the plurality of users linked to the first vehicle transportation order.

8. The system of claim 1, wherein the order information portion is maintained at a top portion of the first user interface and the order communication portion is provided below the order information portion of the first user interface.

9. The system of claim 1, wherein the processing system is configured to generate the first user interface responsive to an update to a status of the first vehicle transportation order.

10. The system of claim 1, wherein the processing system is configured to generate the first user interface responsive to receipt of a second input at a second user interface, wherein the second input is a message related to the first vehicle transportation order, wherein the message includes content that identifies the first vehicle transportation order.

11. The system of claim 1, wherein the input related to the first vehicle transportation order includes a message.

12. The system of claim 1, wherein the processing system is configured to:
receive, via the first user interface, a second input, the second input including a message;
determine whether the second input is related to the first vehicle transportation order; and
when the second input is related to the first vehicle transportation order, update the first user interface to include the second input in the order communication portion.

13. The system of claim 12, wherein the processing system is configured to:
when the second input is related to a second vehicle transportation order, prevent inclusion of the second input in the order communication portion.

14. The system of claim 12, wherein the processing system is configured to:
when the second input is related to a second vehicle transportation order, redirect the second input to a second user interface that is specific to the second vehicle transportation order, wherein the second input is included within a second order communication portion of the second user interface.

15. The system of claim 1, wherein the processing system is configured to:
monitor, using an artificial intelligence (AI) agent, an exchange of communications between a plurality of users linked to the first vehicle transportation order;
determine, using the AI agent, whether the exchange of communications satisfies a trigger condition; and
when the exchange of communications satisfies the trigger condition, execute, using the AI agent, an automated action.

16. The system of claim 15, wherein the trigger condition is related to an amount of time since receipt of the input without a response from a target recipient of the input; and wherein the automated action is to generate an alert indicating that the target recipient is unresponsive.

17. The system of claim 15, wherein the trigger condition is related to inclusion of blocked content in the input; and wherein the automated action is to prevent the blocked content.
